(19) United States
(12) Patent Application Publication
(10) Pub. No.: US 2013/0045411 A1
(43) Pub. Date: Feb. 21, 2013

(54) COOLING DEVICE

(71) Applicants: Swen-Juri Bauer, Stuttgart (DE); Andreas Gruener, Hattenhofen (DE); Roland Schuetzle, Stuttgart (DE)

(72) Inventors: Swen-Juri Bauer, Stuttgart (DE); Andreas Gruener, Hattenhofen (DE); Roland Schuetzle, Stuttgart (DE)

(73) Assignee: MAHLE INTERNATIONAL GMBH, STUTTGART (DE)

(21) Appl. No.: 13/696,067

(22) PCT Filed: Apr. 29, 2011
(86) PCT No.: PCT/EP11/56854

§ 371 Date: Nov. 2, 2012

(30) Foreign Application Priority Data
May 5, 2010 (DE) 10-2010-019-369.0

(51) Int. Cl. H01M 10/50

(52) U.S. Cl. 429/120

(57) ABSTRACT

A battery cooling device for the cooling of battery cell components may include at least one cooling fin extending sinuously and configured to be permeated by at least one of air and coolant. The cooling fin may have at least one of wavelike and steplike shape along its course and may be constructed to be elastic.

### CROSS-REFERENCES TO RELATED APPLICATIONS

This application claims priority to German Patent Application 10 2010 019 369.0, filed on May 5, 2010, and International Patent Application No. PCT/EP2011/056854, filed on Apr. 29, 2011, both of which are hereby incorporated by reference in their entirety.

### TECHNICAL FIELD

The present invention relates to a cooling device for the cooling of components according to the introductory clause of claim 1. The invention further relates to a battery cooler with at least one battery unit/battery cell and a cooling device cooling this.

### BACKGROUND

A cooling device with a housing and with several battery cells arranged in this housing is known from WO 2008/027343 A1.

A corrugated fin is known from U.S. Pat. No. 5,372,187, the corrugation of which serves, however to increase the turbulence of the flowing air.

Heat exchangers, for example, water coolers or oil coolers, are also known, which generally consist of fluid-directing heat exchanger tubes and cooling fins, wherein a cooling fin is situated between every two heat exchanger tubes. Also, in each heat exchanger tube a turbulence fin can also be situated, which is constructed structurally identically or similarly to the cooling fin. Depending on the structure of the heat exchanger, the heat exchanger tubes and the cooling fin are flowed through in the same direction, or in the opposite direction or perpendicularly to one another.

In cooling devices, the problem often exists that cooling fins of such cooling devices are exposed to high temperature (change) stresses and thereby have comparatively high temperature strains. Generally, the cooling devices are to be produced with small manufacturing tolerances, in particular also in order to be able to ensure an optimum heat transmission in the case of high temperature strains. However, such small manufacturing tolerances make the production of the cooling devices comparatively laborious and expensive. Furthermore, with the use of the cooling devices in motor vehicles, vibrations can occur, which are also transferred to the cooling device. In the case of components which are not soldered to one another, a reduction of the heat transmission between the individual components can thereby occur. A further possible source of problem are possible expansions of the components which are to be cooled.

### SUMMARY

The present invention is concerned with the problem of indicating an improved embodiment for a cooling device of the generic type, which in particular permits higher manufacturing tolerances.

This problem is solved according to the invention by the subject matter of the independent claims. Advantageous embodiments are the subject matter of the dependent claims.

The present invention is based on the general idea of constructing individual cooling fins of the cooling device so as to be elastic, whereby they are able to accommodate comparatively great temperature strains without adverse effect, and whereby at the same time they are able to compensate higher manufacturing tolerances. The cooling device according to the invention is constructed here for the cooling of components and has at least one cooling fin extending sinuously, which is permeated by air or coolant. This at least one cooling fin has along the extension thereof in addition a wavelike and/or steplike shape and is thereby constructed so as to be elastic and—as mentioned above—is able to accommodate manufacturing tolerances, temperature strains and other deformations occurring in operation comparatively simply—namely elastically—and above all without adverse effect. In hitherto known unsoldered sinuous cooling fins, this was not possible because these cooling fins were in themselves so rigid that with sufficiently great temperature strains already there was a risk of detachment from the components which are to be cooled and hence a weakening of the heat transfer. The wavelike- and/or steplike shape of the cooling fins according to the invention enables an elastic yielding both in the case of high temperature strains occurring, other deformations, and also for the compensation of manufacturing tolerances, whereby not only are higher manufacturing tolerances tolerable, but in addition also an optimum heat transmission can be ensured in all occurring temperature ranges, because in particular an interruption of the heat transfer, impairing the cooling effect, in particular by a detaching of cooling fins from the components which are to be cooled, can be reliably prevented.

In an advantageous further development of the solution according to the invention, the cooling fin has a stepped shape which can have at least one, but preferably also several steps. This single-step or multiple-step stepped shape again enables an elastic yielding of the individual cooling fins, in particular in the case of temperature strains and/or for the compensation of manufacturing tolerances, wherein the stepping, just as for example an undulation, can be produced simply and thereby also at a favourable cost with regard to manufacture.

In a further advantageous embodiment of the solution according to the invention, the cooling fin is constructed from corrugated sheet metal which is finally converted, i.e. shaped, into a large undulation. To produce the cooling fin according to the invention, therefore firstly a flat sheet is undulated and this is then subsequently bent sinuously, so that the characteristic course for the cooling fin according to the invention is produced. In this case, the cooling fin can be shaped in a single shaping machine, for example by rollers or respectively bending dies connected in succession and constructed accordingly.

The cooling device according to the invention is used in particular in a battery cell stack in a battery cooler, in which high temperatures can occur on charging the battery cells. Also in the case of a high stress/temperature, in particular during driving operation, a cooling can be necessary. The cooling fins form closed cooling channels here with the battery cell, which are permeated by air or coolant for example, and thereby intensify the cooling effect for the battery cells which are to be cooled. In this case, the unit is soldered or welded or otherwise connected together, so that the cooling fin is securely connected with the intermediate layer. According to requirements, such a unit is then inserted as a cooling device between two adjacent battery cells in each case. How many thereof come into use in a battery cell stack depends on the required cooling efficiency. Such a battery cooler is used into particular in electric or hybrid vehicles, but also in normal motor vehicles, in order to reduce a temperature stress of the battery and thereby increase its efficiency or respectively its durability. The battery cells are preferably arranged parallel to one another, wherein at least one cooling fin is arranged between individual battery cells or on the respective front faces thereof. In particular the selected arrangement of the cooling fins between the individual battery cells provides for a high heat exchange and thereby a good cooling.

Further important features and advantages of the invention will emerge from the subclaims, from the drawings and from the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained in further detail in the following description, wherein the same reference numbers refer to identical or similar or functionally identical components.

### BRIEF DESCRIPTION OF THE DRAWINGS

There are shown, respectively diagrammatically

FIG. 1 a cooling device according to the invention, in a sectional illustration,

FIG. 2 a possible embodiment of cooling fins,

FIG. 3 an illustration as in FIG. 2, but with differently shaped cooling fins,

FIG. 4 an example of a further possible embodiment of the cooling fin,

FIG. 5 a battery cooler according to the invention,

FIG. 6 a further embodiment of the battery cooler according to the invention.

### DETAILED DESCRIPTION

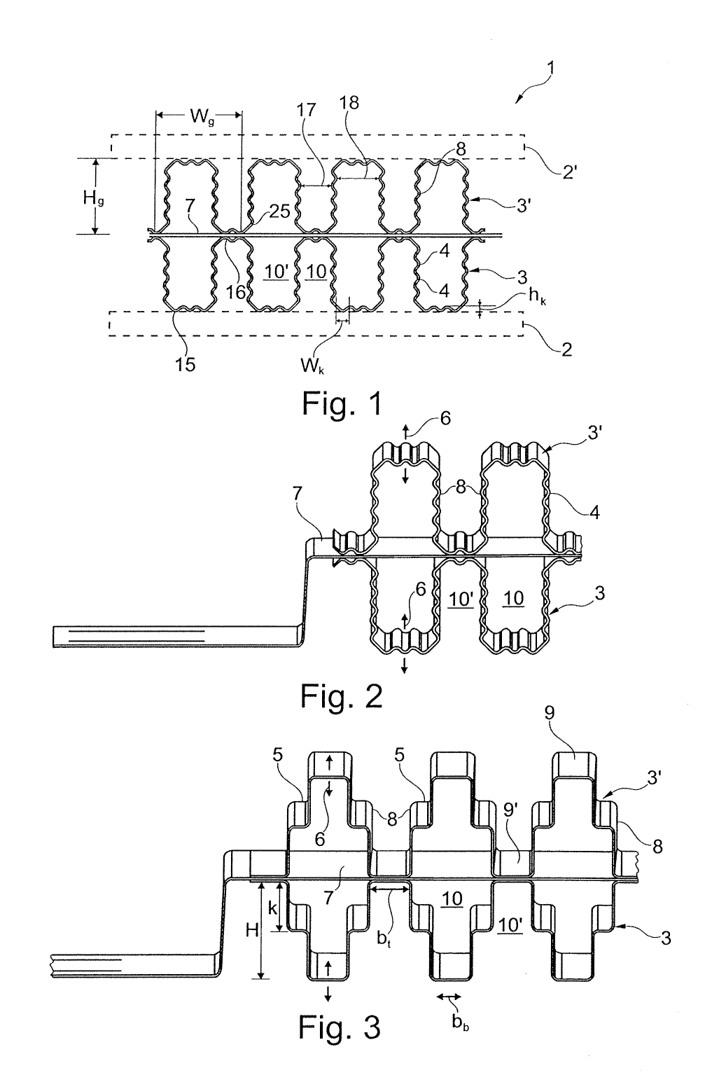

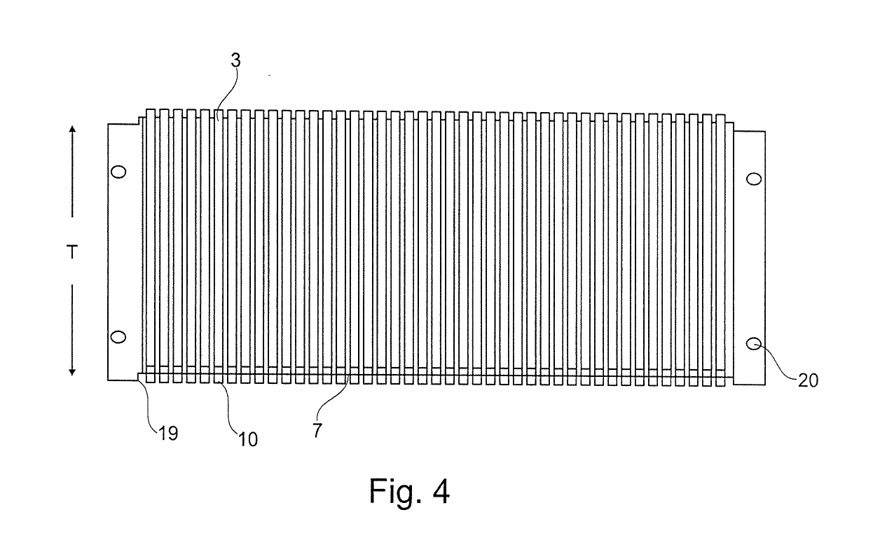

In accordance with FIG. 1, a cooling device 1 according to the invention for the cooling of components 2, 2′ has two cooling fins 3, 3′ extending sinuously, which are permeated by air or coolant. As can be seen from FIGS. 1 to 3, the cooling fins 3 according to the invention have a wavelike shape here along their course (cf. FIGS. 1 and 2), or else a steplike shape (cf. FIG. 3), and are thereby constructed so as to be comparatively elastic. The cooling device 1 can be constructed for example as a battery cooler, wherein in this case the components 2, 2′ are battery cells, in which it is necessary to cool a component surface which becomes heated. In this case, it is not necessary that a medium flows inside the components 2, 2′. Such a component surface can be present, for example, in battery cells, which are rapidly charged at a charging station after use. A cooling of such component surfaces, i.e. surfaces of battery cells, can also be necessary during driving. It can also be the surface of a computer processor, which must be permanently cooled during use. These components 2 and 2′ can also be conventional flat heat exchanger tubes, with medium flowing therein which is to be cooled, so that the sinuously extending cooling fin 3 replaces the normal slotted cooling fin. The cooling fin 3 shown here can also, if required, contain slots (not shown) in the lateral faces 8.

Generally, the cooling fin 3, 3′, constructed according to the invention in a wavelike or steplike manner, can be produced from already pre-corrugated sheet metal, which is finally converted into a large undulation. In this case, therefore, firstly the sheet metal which is still flat is provided with small waves 4 and is subsequently converted or respectively bent into the sinuous shape.

The characteristic structure of the cooling device 1 can be seen with the aid of FIG. 1. The cooling device 3 is composed of three metal sheets 3, 3′ and 7, wherein the metal sheets 3 and 3′ are already constructed as cooling fins 3 and 3′. The cooling fins 3 and 3′ have already been provided with a small corrugation 4 and a large corrugation before joining together. The small corrugation 4 has the wave length Wₖ with an amplitude hₖ. The large corrugation has the wave length W_{g} and the amplitude H_{g} with wave troughs 15 and wave crests 16. The width of the wave crests 18 and the width of the wave troughs 17 does not have to, but may, be of equal size. In the example which is shown, for the cooling fin 3 the wave crests 15 are narrower, i.e. the width 17 is smaller, than the width 18. The designation of wave crest and wave trough is also possible the other way around. Respectively, in the case of the cooling fin 3′, everything is exactly reversed with respect to the cooling fin 3, as the two cooling fins 3 and 3′ are arranged mirror-inverted to one another. The wider wave troughs 15 of the cooling fin 3 touch the component surface of the component 2 which is to be cooled. The smaller corrugation 4, which also occurs in the contact surface of the wave trough 15, is not disturbing to the transfer of heat.

The wave length Wₖ of the smaller corrugation is considerably smaller than that of the large corrugation W_{g}; a ratio of Wₖ to W_{g} of approximately 1 to 4 or 1 to 5 is ideal. However, how the ratio is precisely selected is dependent on the respective use of the cooling device. The amplitudes hₖ and H_{g} of the two corrugations are also different in size. The ratio of hₖ to H_{g} approximately 1 to 10. According to requirements, however, it can also be entirely different. However, the amplitude hₖ of the corrugation 4 must remain so small that it does not impair the transfer of heat in the wave troughs 15 in the contact region 9 of the large corrugation.

At the sites 25 where the wave trough 15 is continued into the wave flank 8 and the wave flank 8 is continued into the wave crest, no corrugation 4 is provided. These sites 25 are straight. Through the interaction of the straight sites 25 with the corrugation 4 in the wave flanks 8, the elasticity of the cooling device 1 is achieved. It is also possible to provide a corrugation 4 in the wave flanks 8, which has a greater amplitude hₖ than the corrugation 4 in the wave crests 16 and wave troughs 15. Also, depending on the choice of the cooling fin forming tool, the sites 25 have either a straight shape or a curved shape.

The three metal sheets 3, 3′ and 7, which together form the cooling device 1, are connected with one another by welding, gluing, pressing or soldering. They thereby form a transportable and manageable unit, which on assembly of non-soldered heat exchangers are stacked alternately with the components 2. In order to assemble a battery cooler, at least one cooling device 1 can be installed between two packs on battery components. Depending on the type of the battery cooler, the entire battery including the cooling device 1 is held together by a frame or by another suitable device.

Through the steplike or respectively wavelike course of the cooling fins 3, 3′, the latter are able to accommodate and to compensate both larger temperature strains and also manufacturing tolerances without adverse effect. In conventional cooling fins having only the sinuous form, but not the wavelike or steplike shape, only small manufacturing tolerances were able to be accepted, in order to be able to reliably avoid an interruption of the heat transmission, for example by a detaching of the cooling fin from the component 2, 2′ which is to be cooled. Through the comparatively elastic construction of the cooling fins 3, 3′ according to the invention, these can also accommodate greater manufacturing tolerances or respectively higher temperature strains without a problem, without it having to be feared here that a heat-transmitting contact is interrupted between the cooling fins 3, 3′ and the components 2, 2′ which are to be cooled, for example the battery cells.

If one observes the cooling fins 3, 3′ according to FIG. 3, it can be seen that these have a stepped shape with one or more steps 5 in the wave flanks 8. Such a stepped shape, similarly to a corrugated shape (cf. FIGS. 1 and 2), also results in a certain elasticity of the cooling fins 3, 3′, in particular in the direction 6, and is thereby able to easily accommodate temperature strains and/or manufacturing tolerances and/or other deformations during operation.

Here, also, the cooling fin 3 has a wave length W with an amplitude H, and wave crests 16 and wave troughs 15. The wave troughs 15 of the cooling fin 3 have no small corrugation 4 in the contact surface 9. The steps 5 in the wave flanks 8 can be formed in at a distance h of the contact surfaces 9 of the wave crests 16. The ratio of k to H can be approximately 1 to 2, or else arbitrarily different, according to the requirement for the cooling device 1. The wave crests 16 have an associated width b_{b}, and the wave troughs have an associated width bₜ. In the example shown in FIG. 3, bₜ and b_{b} are of equal size. This ratio is also to be selected according to requirements. The cooling fins 3 and 3′ are connected with the metal sheet 7 by weld spots or other possibilities for connection in the support surfaces 9′, and thus form the cooling device 1. The contact surfaces 9 and 9′ of the wave crests or respectively wave troughs can be of equal size, but do not have to be.

Several steps 5 can also be provided in the wave flanks 8. The example in FIG. 3 shows relatively large contact surfaces 9 and 9′; depending on the application of the cooling device 1, the contact surface 9, which touches the components 2, can be large whereas the contact surface 9′ to the metal sheet 7 can be minimal.

Preferably, moreover, a metal sheet is arranged as an intermediate layer 7 between two cooling fin rows 3, 3′ respectively, so that, as is shown according to FIG. 1, respectively two cooling fin rows 3, 3′ on the one hand are connected via the shared intermediate layer 7, and on the other hand are linked in a heat-transmitting manner to the component 2, 2′ which is to be cooled respectively, wherein the metal sheet 7 serves for stabilizing the cooling device 1. Of course, a mixed form of cooling fins 3, 3′ is also conceivable, so that the latter, for example on cross-pieces 8, have a corrugated form, whereas at contact regions 9 and 9′ (cf. FIG. 3) they have a flat shape and therefore produce a flat and readily transmitting thermal contact to the metal sheet 7 or respectively to the components 2, 2′ which are to be cooled.

FIG. 4 shows what such a cooling fin 3 can look like. All the dimensions can be varied depending on the case of application. The cooling device 1 has fastening holes 20 in the metal sheet 7 on the edge. It is fastened with these holes to the frame of a battery, so that the cooling device 1 is in contact with the components of the battery. The cooling channels 10 and 10′, extending along the length T, can be clearly seen. The cooling air is blown through these, in order to cool the components 2, 2′. Depending on the case of application and the structure of the battery, the metal sheet 7, i.e. the intermediate layer 7, has a kink 19, so that the cooling device 1 can be fastened to the frame of the battery or to the nearest component 2.

The small corrugations 4 and the large corrugations are straight in the T direction.

The cooling device 1 according to the invention is used in particular in a battery cell stack in a battery cooler 30, in which high temperatures can occur during charging or during operation of the battery cells 31. The cooling fins 3, 3′ form closed cooling channels 10, 10′ with the component 2, 2′ which is to be cooled, or respectively with the metal sheet 7, which cooling channels are permeated for example by air or coolant and thereby intensify the cooling effect for the components 2, 2′ which are to be cooled. In this case, the unit shown in FIG. 4 is soldered or welded or otherwise connected together, so that the cooling fin 3, 3′ is securely connected with the intermediate layer 7. According to requirements, such a unit is then inserted as a cooling device 1 between respectively two adjacent battery cells 31. How many thereof come to be used in a battery cell stack depends on the required cooling efficiency.

Higher manufacturing tolerances can be compensated and at the same time higher temperature strains can be accommodated with the cooling fins 3, 3′ which are constructed so as to be corrugated and/or stepped according to the invention, without an impairment to the cooling effect thereby having to be feared.

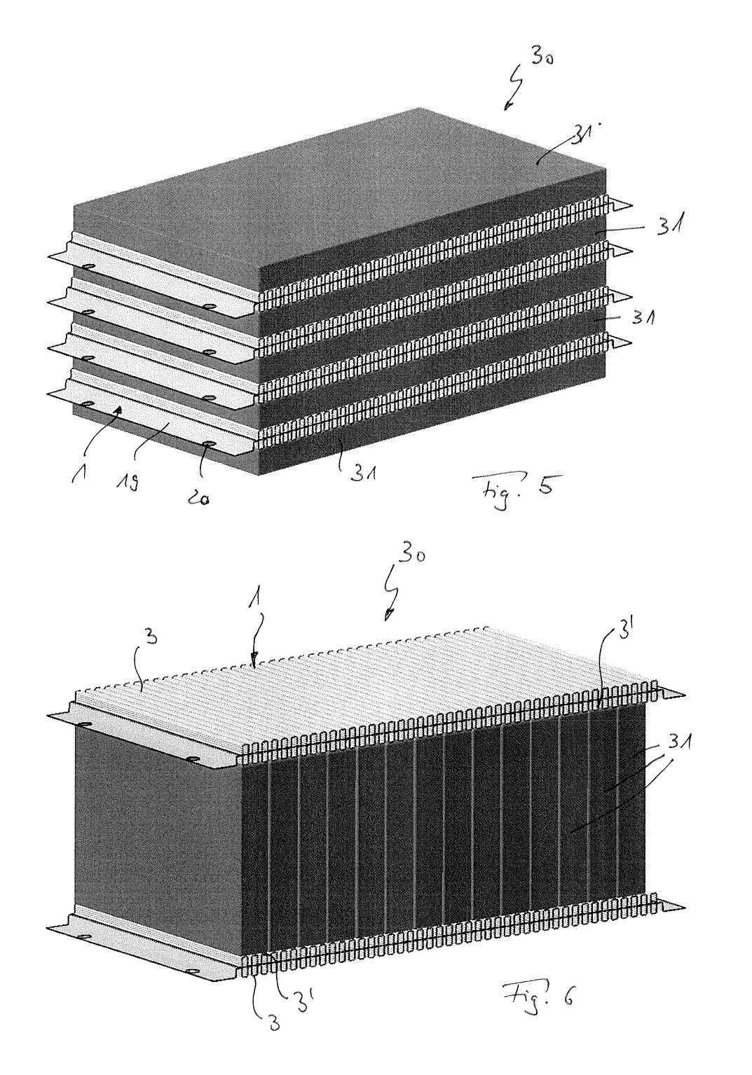

In accordance with FIGS. 5 and 6, a battery cooler 30 is illustrated, which usually has a plurality of battery units, i.e. battery cells 31. Such a battery cooler 30 is used in particular in hybrid or electric vehicles, but also in normal motor vehicles, in order to reduce a temperature stress of the battery and thereby to increase its performance or respectively its durability. The cooling device 1 according to the invention can be used here for cooling the battery units or respectively the battery cells 31. In particular in the case of lithium ion batteries, a cooling can also be relevant to safety. Above all, however, the durability of the battery cells 31 can be increased by a suitable temperature management.

The battery cells 31 are preferably arranged parallel to one another, wherein at least one cooling fin (3, 3′) is arranged between individual battery cells 31 or on their respective front faces. In particular the selected arrangement of the cooling fins 3, 3′ between the individual battery cells 31 provides for a high heat exchange and thereby for a good cooling.

1. A battery cooling device for the cooling of battery cell components,
comprising:
at least one cooling fin extending sinuously and configured to be permeated by at least one of air and coolant,
wherein the at least one cooling fin has at least one of wavelike and steplike shape along its course and is constructed to be elastic.

2. The battery cooling device according to claim 1,
wherein
the at least one cooling fin is constructed from corrugated sheet metal and shaped into a large undulation.

3. The battery cooling device according to claim 1,
wherein
the at least one cooling fin has a stepped shape.

4. The battery cooling device according to claim 1,
wherein the at least one cooling fin includes a plurality of fins forming two cooling fin rows, the cooling rows being connected via a shared intermediate layer and linked to the battery cell component.

5. The battery cooling device according to claim 4,
wherein
the plurality of cooling fins are connected in a heat-transmitting manner with the components.

6. The battery cooling device according to claim 4,
wherein
the battery cell components are arranged at least one of orthogonally and parallel to the plurality of cooling fins.

7. A battery cooler with at least one battery cell and a cooling device, comprising:
at least one cooling fin extending sinuously and configured to be permeated by at least one of air and coolant, wherein the at least one cooling fin has at least one of wavelike and steplike shape along its course and is constructed to be elastic.

8. The battery cooler according to claim 7,
wherein the at least one battery cell includes
a plurality of battery cells respectively arranged parallel to one another.

9. The battery cooler according to claim 7,
wherein
the at least one cooling fin is arranged at least one of between individual battery cells and on their respective front faces of the battery cell.

10. (canceled)

11. The battery cooler according to claim 7, wherein the at least one cooling fin is constructed from corrugated sheet metal and shaped into a large undulation.

12. The battery cooler according to claim 7, wherein the at least one cooling fin has a stepped shape.

13. The battery cooler according to claim 7, wherein the at least one cooling fin includes a plurality of fins forming two cooling fin rows, the cooling rows being connected via a shared intermediate layer and linked to the battery cell.

14. The battery cooler according to claim 13, wherein the plurality of cooling fins are connected in a heat-transmitting manner with the battery cell.

15. The battery cooler according to claim 13, wherein the battery cell is arranged at least one of orthogonally and parallel to the plurality of cooling fins.

16. The battery cooler according to claim 2, wherein the at least one cooling fin has a stepped shape.

17. The battery cooler according to claim 2, wherein the at least one cooling fin includes a plurality of fins forming two cooling fin rows, the cooling rows being connected via a shared intermediate layer and linked to the battery cell.

18. The battery cooler according to claim 5, wherein the battery cell is arranged at least one of orthogonally and parallel to the plurality of cooling fins.
